(19) United States
(12) Patent Application Publication
(10) Pub. No.: US 2006/0164938 A1
(43) Pub. Date: Jul. 27, 2006

(54) Reproducing apparatus capable of reproducing picture data

(76) Inventor: Shinji Kuno, Ome-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/326,106

(22) Filed: Dec. 30, 2005

(30) Foreign Application Priority Data
Jan. 4, 2005 (JP) 2005-000246

(51) Int. Cl. G11B 5/09

(52) U.S. Cl. 369/47.1; 369/30.01

(57) ABSTRACT

A reproducing apparatus includes an execution unit that executes a separation process by a program on a motion video stream including first video data, and graphics data that includes second video data, and executes a decoding process by a program on the second video data that is obtained through the separation process, a decoder that decodes the first video data, which is obtained through the separation process, and a blending process unit that blends the first video data, which is decoded by the decoder, and the graphics data including the second video data, which is decoded by the decoding process in the execution unit.

### CROSS-REFERENCE TO RELATED APPLICATIONS

This application is based upon and claims the benefit of priority from prior Japanese Patent Application No. 2005-000246, filed Jan. 4, 2005, the entire contents of which are incorporated herein by reference.

### BACKGROUND OF THE INVENTION

1. Field of the Invention

The present invention relates to a reproducing apparatus such as a high definition digital versatile disc (HD-DVD) player.

2. Description of the Related Art

In recent years, with a progress in digital compression-encoding technology for motion video, reproducing apparatuses (players), which can handle high-definition video according to the high definition (HD) standard, have steadily been developed.

In this type of player, there is a need to efficiently execute a separating/decoding process at a time of reading out compression-encoded data from a recording medium and reproducing the data.

Jpn. Pat. Appln. KOKAI Publication No. 8-205092, for instance, discloses an MPEG2 decoder that receives an MPEG bit stream, which is read out of a drive and transferred, separates the MPEG bit stream into video, sub-picture and audio packets, and decodes these packets.

According to the prior-art technique of this document, however, not only data relating to main video but also data relating to sub-video is subjected to a separating and decoding process by hardware. Thus, if a change in system specifications (e.g. a change in specifications relating to sub-video processing) occurs in the future, this prior-art technique cannot flexibly cope with such a change.

Under the circumstances, there is a demand for a technique that can flexibly cope with a change in specifications of a reproducing apparatus.

### BRIEF SUMMARY OF THE INVENTION

According to one aspect of the present invention, there is provided a reproducing apparatus comprising an execution unit that executes a separation process by a program on a motion video stream including first video data, and graphics data that includes second video data, and executes a decoding process by a program on the second video data that is obtained through the separation process; a decoder that decodes the first video data, which is obtained through the separation process; and a blending process unit that blends the first video data, which is decoded by the decoder, and the graphics data including the second video data, which is decoded by the decoding process in the execution unit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram that shows the structure of a reproducing apparatus according to an embodiment of the present invention;

FIG. 2 shows the structure of a player application that is used in the reproducing apparatus shown in FIG. 1;

FIG. 3 is a view for explaining the functional structure of a software decoder that is realized by the player application shown in FIG. 2;

FIG. 4 is a view for explaining a blending process that is executed by a blending process unit, which is provided in the reproducing apparatus shown in FIG. 1;

FIG. 5 is a view for explaining a blending process that is executed by a GPC, which is provided in the reproducing apparatus shown in FIG. 1;

FIG. 6 shows a state in which sub-video data is overlaid on main video data in the reproducing apparatus shown in FIG. 1;

FIG. 7 shows a state in which main video data is displayed on a partial area of sub-video data in the reproducing apparatus shown in FIG. 1;

FIG. 8 illustrates an operation in which main video data and graphics data are transferred to the blending process unit in the reproducing apparatus shown in FIG. 1;

FIG. 9 illustrates a state in which graphics data and alpha data are transferred in synchronism in the reproducing apparatus shown in FIG. 1;

FIG. 10 illustrates a state in which graphics data and alpha data are transferred over different transmission lines in the reproducing apparatus shown in FIG. 1; and

FIG. 11 is a block diagram that shows the structure of the blending process unit that is provided in the reproducing apparatus shown in FIG. 1.

### DETAILED DESCRIPTION OF THE INVENTION

Embodiments of the present invention will be described below with reference to the drawings.

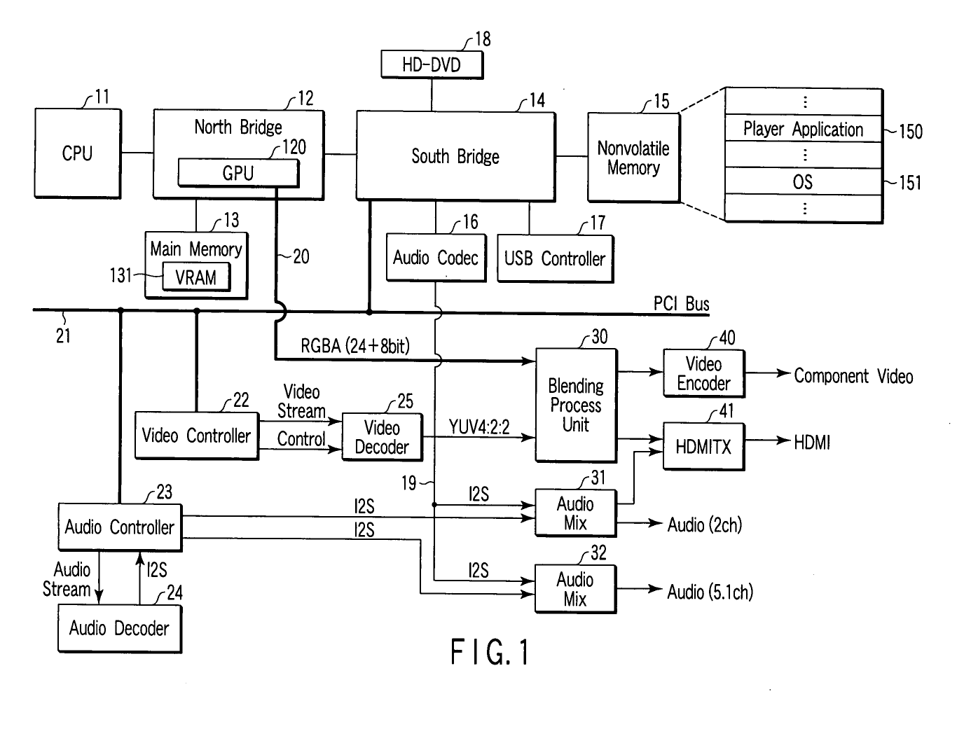

FIG. 1 shows an example of the structure of a reproducing apparatus according to an embodiment of the present invention. The reproducing apparatus is a media player that reproduces audio/video (AV) content. The reproducing apparatus is realized as an HD-DVD player that reproduces audio/video (AV) content, which is stored on DVD media according to HD-DVD (High Definition Digital Versatile Disc) standard.

As is shown in FIG. 1, the HD-DVD player includes a central processing unit (CPU) 11, a north bridge 12, a main memory 13, a south bridge 14, a nonvolatile memory 15, an audio codec 16, a universal serial bus (USB) controller 17, an HD-DVD drive 18, an audio bus 19, a graphics bus 20, a peripheral component interconnect (PCI) bus 21, a video controller 22, an audio controller 23, an audio decoder 24, a video decoder 25, a blending process unit 30, audio mixers 31, 32, a video encoder 40, and an AV interface (HDMI-TX) 41 such as a high definition multimedia interface (HDMI).

In this HD-DVD player, a player application 150 and an operating system (OS) 151 are preinstalled in the nonvolatile memory 15. The player application 150 is software that runs on the OS 151, and executes a control to reproduce AV content that is read out of the HD-DVD drive 18.

AV content, which is stored on HD-DVD media, which is driven by the HD-DVD drive 18, contains a motion video stream (HD-DVD stream) such as a stream that is compression-encoded by H.264 or MPEG2 format. In the HD-DVD stream, compression-encoded main video data (motion video), compression-encoded main audio data, compression-encoded graphics data including alpha data, and compression-encoded sub-audio data are multiplexed.

The compression-encoded main video data is data that is obtained by encoding motion video data, which is used as main video (main screen picture), according to the H.264/AVC encoding scheme. The main video data contains an HD standard high-definition picture. Alternatively, main video data according to standard definition (SD) scheme can be used. The compression-encoded graphics data is sub-video (sub-screen picture) that is displayed in a state in which the sub-video is overlaid on main video. The graphics data contains sub-video data, which is formed of motion video that supplements the main video, sub-picture data including text (e.g., caption)/still picture, and navigation data (Advanced Navigation) for displaying operation guidance such as a menu object. The navigation data contains still picture/motion video (including animation)/text. The navigation data includes a script in which the motion of an object picture such as a menu object is described. The script is interpreted and executed by the CPU 11. Thereby, a menu object with high interactivity can be displayed on main video.

These sub-video data, sub-picture data and navigation data are compression-encoded.

The HD-standard main video has a resolution of, e.g., 1920×1080 pixels or 1280×720 pixels. Each of the sub-video data, sub-picture data and navigation data has a resolution of, e.g., 720×480 pixels.

In this HD-DVD player, software (player application 150) executes a separation process for separating main video data, main audio data, graphics data and sub-audio data from a HD-DVD stream that is read out from the HD-DVD drive 18, and a decoding process for decoding the graphics data and sub-audio data. On the other hand, dedicated hardware executes a decoding process for decoding main video data and main audio data, which typically use a greater amount of processing.

The CPU 11 is a processor that is provided in order to control the operation of the HD-DVD player. The CPU 11 executes the OS 151 and player application 150, which are loaded from the nonvolatile memory 15 into the main memory 13. In one embodiment, a part of the memory area within the main memory 13 is used as a video memory (VRAM) 131. It is not necessary, however, to use a part of the memory area within the main memory 13 as the VRAM 131. The VRAM 131 can be provided as a memory device that is independent from the main memory 13.

The north bridge 12 is a bridge device that connects a local bus of the CPU 11 and the south bridge 14. The north bridge 12 includes a memory controller that access-controls the main memory 13. The north bridge 12 also includes a graphics processing unit (GPU) 120.

The GPU 120 is a graphics controller that generates graphics data (also referred to as graphics picture data), which forms a graphics screen picture, from data that is written by the CPU 11 in the video memory (VRAM) 131 that is assigned to the partial memory area of the main memory 13. The GPU 120 generates graphics data using a graphics arithmetic function such as bit block transfer. For example, in a case where picture data (sub-video, sub-picture, navigation) are written in three planes in the VRAM 131 by the CPU 11, the GPU 120 executes a blending process, with use of bit block transfer, which blends the picture data corresponding to the three planes on a pixel-by-pixel basis, thereby generating graphics data for forming a graphics screen picture with the same resolution (e.g., 1920×1080 pixels) as the main video. The blending process is executed using alpha data that are associated with the picture data of sub-video, sub-picture and navigation, respectively. The alpha data is a coefficient representative of the degree of transparency (or non-transparency) of each pixel of the associated picture data. The alpha data corresponding to the sub-video, sub-picture and navigation are multiplexed on the stream along with the picture data of the sub-video, sub-picture and navigation. Specifically, each of the sub-video, sub-picture and navigation included in the stream contains picture data and alpha data.

The graphics data that is generated by the GPU 120 has an RGB color space. Each pixel of the graphics data is expressed by digital RGB data (24 bits).

The GPU 120 includes not only the function of generating graphics data that forms a graphics screen picture, but also a function of outputting alpha data, which corresponds to the generated graphics data, to the outside.

Specifically, the GPU 120 outputs the generated graphics data to the outside as an RGB video signal, and outputs the alpha data, which corresponds to the generated graphics data, to the outside. The alpha data is a coefficient (8 bits) representative of the transparency (or non-transparency) of each pixel of the generated graphics data (RGB). The GPU 120 outputs, on a pixel-by-pixel basis, alpha-data-added graphics data (32-bit RGBA data), which contains graphics data (24-bit digital RGB video signal) and alpha data (8-bit). The alpha-data-added graphics data (32-bit RGBA data) is sent to the blending process unit 30 in sync with each pixel over the dedicated graphics bus 20. The graphics bus 20 is a transmission line that is connected between the GPU 120 and the blending process unit 30.

In this HD-DVD player, the alpha-data-added graphics data is directly sent from the GPU 120 to the blending process unit 30 via the graphics bus 20. Thus, there is no need to transfer the alpha data from the VRAM 131 to the blending process unit 30 via, e.g., the PCI bus 21, and it is possible to avoid an increase in traffic of the PCI bus 21 due to the transfer of alpha data.

If the alpha data were to be transferred from the VRAM 131 to the blending process unit 30 via, e.g., the PCI bus 21, it would typically be necessary to synchronize the graphic data output from the GPU 120 and the alpha data transferred via the PCI bus 21 within the blending process unit 30. This leads to complexity in structure of the blending process unit 30. In this HD-DVD player, the GPU 120 outputs the graphics data and alpha data by synchronizing them on a pixel-by-pixel basis. Therefore, synchronization between the graphics data and alpha data can easily be realized.

The south bridge 14 controls the devices on the PCI bus 21. The south bridge 14 includes an IDE (Integrated Drive Electronics) controller for controlling the HD-DVD drive 18. The south bridge 14 has a function of accessing the nonvolatile memory 15, USB controller 17 and audio codec 16.

The HD-DVD drive 18 is a drive unit for driving storage media such as HD-DVD media that stores audio/video (AV) content according to the HD-DVD standard.

The audio codec 16 converts software-decoded sub-audio data to an I2S (Inter-IC Sound) format digital audio signal. The audio codec 16 is connected to the audio mixers (Audio Mix) 31 and 32 via the audio bus 19. The audio bus 19 is a transmission line that is connected between the audio codec 16 and the audio mixers (Audio Mix) 31 and 32. The audio bus 19 transfers the digital audio signal from the audio codec 16 to the audio mixers (Audio Mix) 31 and 32, not through the PCI bus 21.

The video controller 22 is connected to the PCI bus 21. The video controller 22 is an LSI for executing interface with the video decoder 25. A stream (Video Stream) of main video data, which is separated from the HD-DVD stream by software, is sent to the video decoder 25 via the PCI bus 21 and video controller 22. In addition, decode control information (Control) that is output from the CPU 11 is sent to the video decoder 25 via the PCI bus 21 and video controller 22.

In one embodiment, the video decoder 25 is a decoder that supports the H.264/AVC standard. The video decoder 25 decodes HD-standard main video data and generates a digital YUV video signal that forms a video screen picture with a resolution of, e.g., 1920×1080 pixels. The digital YUV video signal is sent to the blending process unit 30.

The audio controller 23 is connected to the PCI bus 21. The audio controller 23 is an LSI for executing interface with the audio decoder 24. A stream (Audio Stream) of main video data, which is separated from the HD-DVD stream by software, is sent to the audio decoder 24 via the PCI bus 21 and audio controller 23.

The audio decoder 24 decodes the main audio data and generates an I2S (Inter-IC Sound) format digital audio signal. This digital audio signal is sent to the audio mixers (Audio Mix) 31 and 32 via the audio controller 23.

The blending process unit 30 is connected to the GPU 120 and video decoder 25, and executes a blending process for blending graphics data, which is output from the GPU 120, and main video data, which is decoded by the video decoder 25. Specifically, this blending process is a blending process (alpha blending process) for blending, on a pixel-by-pixel basis, the digital RGB video signal, which forms the graphics data, and the digital YUV video signal, which forms the main video data, on the basis of the alpha data that is output along with the graphics data (RGB) from the GPU 120. In this case, the main video data is used as a lower-side screen picture, and the graphics data is used as an upper-side screen picture that is overlaid on the main video data.

The output picture data that is obtained by the blending process is delivered, for example, as a digital YUV video signal, to the video encoder 40 and AV interface (HDMI-TX) 41. The video encoder 40 converts the output picture data (digital YUV video signal), which is obtained by the blending process, to a component video signal or an S-video signal, and outputs it to an external display device (monitor) such as a TV receiver. The AV interface (HDMI-TX) 41 outputs digital signals including the digital YUV video signal and digital audio signal to an external HDMI device.

The audio mixer (Audio Mix) 31 mixes the sub-audio data, which is decoded by the audio codec 16, and the main audio data, which is decoded by the audio decoder 24, and outputs the mixed result as a stereo audio signal. The audio mixer (Audio Mix) 32 mixes the sub-audio data, which is decoded by the audio codec 16, and the main audio data, which is decoded by the audio decoder 24, and outputs the mixed result as a 5.1 channel audio signal.

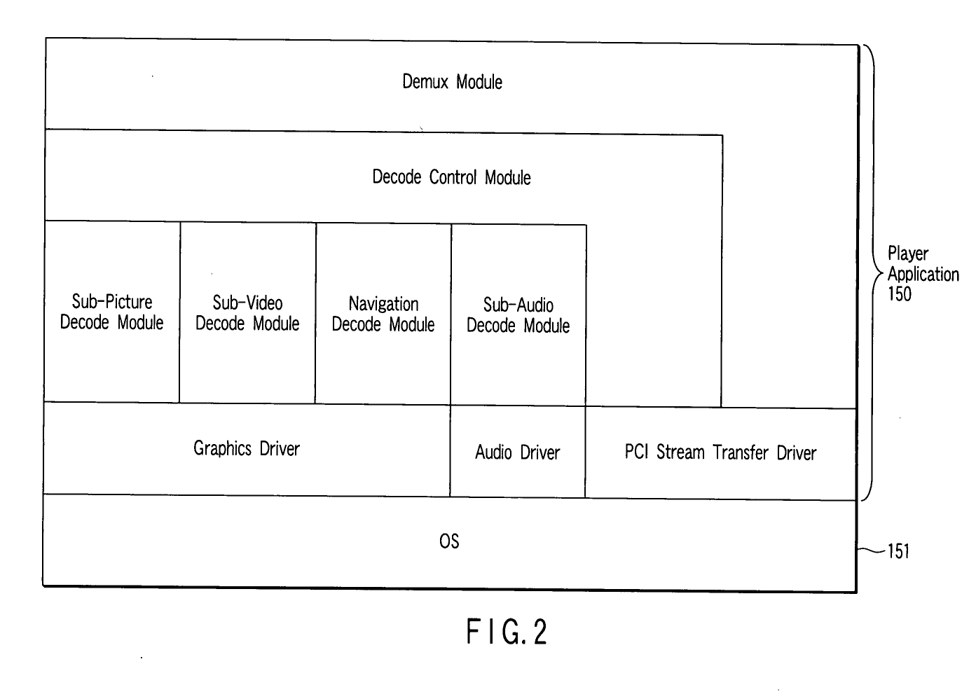

Next, referring to FIG. 2, the structure of the player application 150, which is executed by the CPU 11, is described.

The player application 150 includes a demultiplex (Demux) module, a decode control module, a sub-picture (Sub-Picture) decode module, a sub-video (Sub-Video) decode module, a navigation (Navigation) decode module, a sub-audio (Sub-Audio) decode module, a graphics driver, an audio driver, and a PCI stream transfer driver.

The Demux module is software that executes a demultiplex process for separating, from the stream read out of the HD-DVD drive 18, main video data, main audio data, graphics data (sub-picture data, sub-video data and navigation data), and sub-audio data. The decode control module is software that controls decoding processes for the main video data, main audio data, graphics data (sub-picture data, sub-video data and navigation data), and sub-audio data. The control of the decoding processes is executed on the basis of, e.g., reproduction control information, which is multiplexed on the HD-DVD stream. The reproduction control information is information for controlling a reproduction procedure for the main video data and graphics data (sub-picture data, sub-video data and navigation data).

The sub-picture (Sub-Picture) decode module decodes the sub-picture data. The sub-video (Sub-Video) decode module decodes the sub-video data. The navigation (Navigation) decode module decodes the navigation data. The sub-audio (Sub-Audio) module decodes the sub-audio data.

The graphics driver is software for controlling the GPU 120. The decoded sub-picture data, decoded sub-video data and decoded navigation are sent to the GPU 120 via the graphics driver. The graphics driver issues various rendering instructions to the GPU 120.

The audio driver is software for controlling the audio codec 16. The decoded sub-audio data is sent to the audio codec 16 via the audio driver.

The PCI stream transfer driver is software for transferring the stream via the PCI bus 21. The main video data and main audio data are transferred by the PCI stream transfer driver to the video decoder 25 and audio decoder 24 via the PCI bus 21.

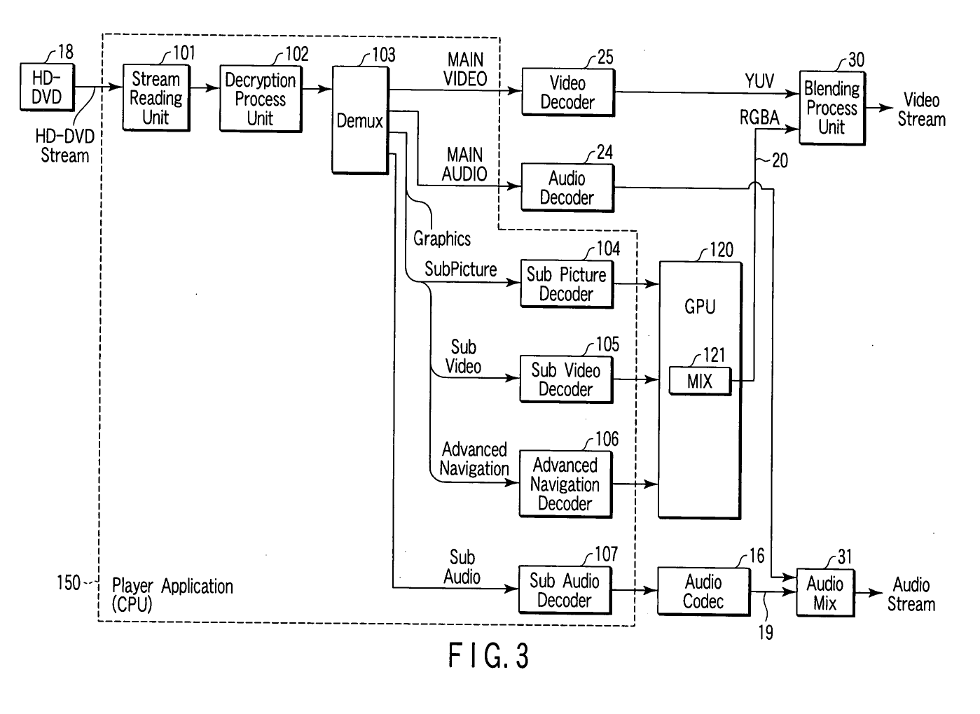

Next, referring to FIG. 3, a description is given of the functional structure of the software decoder that is realized by the player application 150, which is executed by the CPU 11.

The software decoder, as shown in FIG. 3, includes a stream reading unit 101, a decryption process unit 102, a demultiplex (Demux) unit 103, a sub-picture decoder 104, a sub-video decoder 105, an advanced navigation decoder 106, and a sub-audio decoder 107.

The stream (HD-DVD stream) that is stored on the HD-DVD media in the HD-DVD drive 18 is read out of the HD-DVD drive 18 by the stream reading unit 101. The HD-DVD stream is encrypted by, e.g., content scrambling system (CSS). The HD-DVD stream that is read out of the HD-DVD media by the stream reading unit 101 is input to the decryption process unit 102. The decryption process unit 102 executes a process for decrypting the HD-DVD stream. The decrypted HD-DVD stream is input to the demultiplex (Demux) unit 103. The Demux 103 is realized by the Demux module in the player application 150. The Demux 103 separates, from the HD-DVD stream, main video data (MAIN VIDEO), main audio data (MAIN AUDIO), graphics data (Sub-Picture, Sub-Video and Advanced Navigation) and sub-audio data (Sub-Audio).

The main video data (MAIN VIDEO) is sent to the video decoder 25 via the PCI bus 21. The main video data (MAIN VIDEO) is decoded by the video decoder 25. The decoded main video data has a resolution of 1920×1080 pixels according to the HD standard, and is sent to the blending process unit 30 as a digital YUV video signal. The main audio data (MAIN AUDIO) is sent to the audio decoder 24 via the PCI bus 21. The main audio data (MAIN AUDIO) is decoded by the audio decoder 24. The decoded main audio data (MAIN AUDIO) is sent to the audio mixer 31 as an I2S-format digital audio signal.

The sub-picture data, sub-video data and advanced navigation data are sent to the sub-picture decoder 104, sub-video decoder 105 and advanced navigation decoder 106. The sub-picture decoder 104, sub-video decoder 105 and advanced navigation decoder 106 are realized by the sub-picture (Sub-Picture) decode module, sub-video (Sub-Video) decode module and navigation (Navigation) decode module of the player application 150. The sub-picture data, sub-video data and advanced navigation data, which have been decoded by the sub-picture decoder 104, sub-video decoder 105 and advanced navigation decoder 106, are written in the VRAM 131. The sub-picture data, sub-video data and advanced navigation data, which have been written in the VRAM 131, include RGB data and alpha data (A) in association with each pixel.

The sub-audio data is sent to the sub-audio decoder 107. The sub-audio decoder 107 is realized by the sub-audio (Sub-audio) decode module of the player application 150. The sub-audio data is decoded by the sub-audio decoder 107. The decoded sub-audio data is converted to an I2S-format digital audio signal by the audio codec 16, and is sent to the audio mixer 31.

The GPU 120 generates graphics data for forming a graphics screen picture of 1920×1080 pixels, on the basis of the decoded results of the sub-picture decoder 104, sub-video decoder 105 and advanced navigation decoder 106, that is, picture data corresponding to the sub-picture data, sub-video data and advanced navigation data, which are written in the VRAM 131 by the CPU 11. In this case, the three picture data corresponding to the sub-picture data, sub-video data and advanced navigation data are blended by an alpha blending process that is executed by a mixer (MIX) unit 121 of the GPU 120.

In this alpha blending process, alpha data corresponding to the three picture data written in the VRAM 131 are used. Specifically, each of the three picture data written in the VRAM 131 contains RGB data and alpha data. The mixer (MIX) unit 121 executes the blending process on the basis of the alpha data of the three picture data and position information of each of the three picture data, which is told from the CPU 11. Thereby, the mixer (MIX) unit 121 generates a graphics screen picture, which includes, for instance, the three picture data that are at least partly blended. As regards an area where the picture data are blended, new alpha data corresponding to the area is calculated by the mixer (MIX) unit 121. The colors of the pixels in that area in the graphics screen picture of 1920×1080 pixels, which includes no effective picture data, are black. The alpha value corresponding to the pixels in the area, which includes no effective picture data, is a value (alpha=0) that indicates that these pixels are transparent.

In this way, the GPU 120 generates the graphics data (RGB) that form the graphics screen picture of 1920×1080 pixels, and the alpha data corresponding to the graphics data, on the basis of the decoded results of the sub-picture decoder 104, sub-video decoder 105 and advanced navigation decoder 106. As regards a scene in which only one of the pictures of the sub-picture data, sub-video data and advanced navigation data, or the GPU 120 generates graphics data that corresponds to a graphics screen picture, in which the picture (e.g., 720×480) is disposed on the surface of 1920×1080 pixels, and alpha data corresponding to the graphics data.

The graphics data (RGB) and alpha data, which are generated by the GPU 120, are sent as RGBA data to the blending process unit 30 via the graphics bus 20.

As has been described above, according to the structure shown in FIG. 3, the decoding process for graphics and the decoding process for sub-audio, as well as the decryption process and separation process that correspond to preceding-stage processes for reproduction, are realized by software (program). Thus, even if a change in system specifications (e.g. a change in specifications relating to graphics processing) occurs in the future, the structure shown in FIG. 3 can easily cope with such a change by updating the software. In addition, the decoding process, mixing process and blending process for main video and main audio, which require a great deal of processing, are realized by dedicated hardware. Therefore, high-quality video/audio reproduction can be maintained.

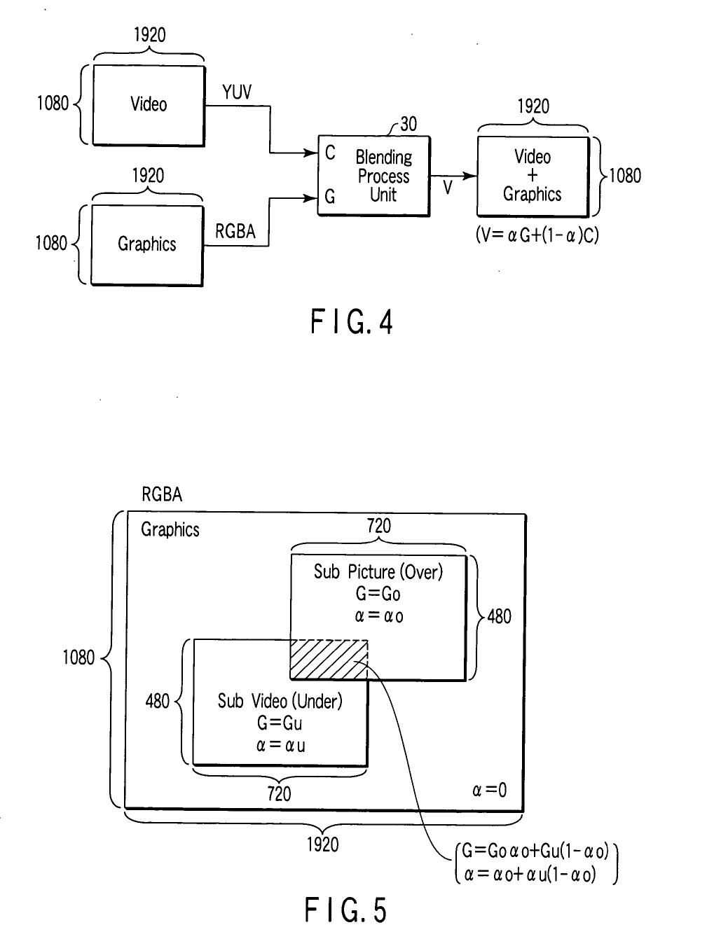

Next, referring to FIG. 4, the blending process (alpha blending process) that is executed by the blending process unit 30 is explained.

The alpha blending process is a blending process in which graphics data and main video data are blended on a pixel-by-pixel basis, on the basis of alpha data (A) that accompanies the graphics data (RGB). In this case, the graphics data (RGB) is used as an oversurface and is laid on the video data. The resolution of the graphics data that is output from the GPU 120 is equal to that of the main video data that is output from the video decoder 25.

Assume now that main video data (Video) with a resolution of 1920×1080 pixels was input to the blending process unit 30 as picture data C, and graphics data with a resolution of 1920×1080 pixels was input to the blending process unit 30 as picture data G. In this case, on the basis of alpha data (A) with a resolution of 1920×1080 pixels, the blending process unit 30 executes an arithmetic operation for overlaying the picture data G on the picture data C in units of a pixel. This arithmetic operation is executed by the following equation (1):
V=α×G30 (1−α)C (1)

where V is the color of each pixel of output picture data obtained by the alpha blending process, and α is the alpha value corresponding to each pixel of graphics data G.

Next, referring to FIG. 5, the blending process (alpha blending process), which is executed by the MIX unit 121 of the GPU 120, is explained.

Assume now that graphics data with a resolution of 1920×1080 pixels is generated from the sub-picture data and sub-video data that are written in the VRAM 131. Each of the sub-picture data and sub-video data has a resolution of, e.g., 720×480 pixels. In this case, each of the sub-picture data and sub-video data is accompanied with alpha data with a resolution of, e.g., 720×480 pixels.

For example, a picture corresponding to the sub-picture data is used as an oversurface, and a picture corresponding to the sub-video data is used as an undersurface.

The color of each pixel in an area where the picture corresponding to the sub-picture data and the picture corresponding to the sub-video data overlap is given by the following equation (2):
G=Go×αo+Gu(1−αo) (2)

where G is the color of each pixel in the overlapping area, Go is the color of each pixel of the sub-picture data that is used as an oversurface, αo is the alpha value of each pixel of the sub-picture data that is used as an oversurface, and Gu is the color of each pixel of the sub-video that is used as an undersurface.

The alpha value of each pixel in an area where the picture corresponding to the sub-picture data and the picture corresponding to the sub-video data overlap is given by the following equation (3):
α=αo+αu×(1−αo) (3)

where α is the alpha value of each pixel in the overlapping area, and au is the alpha value of each pixel of the sub-video data that is used as an undersurface.

In this way, the MIX unit 121 of the GPU 120 blends the sub-picture data and sub-video data by using that one of the alpha data corresponding to the sub-picture data and the alpha data corresponding to the sub-video data, which is to be used as the oversurface. Thereby, the MIX unit 121 generates graphics data for forming a screen picture of 1920×1080 pixels. Further, the MIX unit 121 of the GPU 120 calculates the alpha value of each pixel of the graphics data for forming a screen picture of 1920×1080 pixels, on the basis of the alpha data corresponding to the sub-picture data and the alpha data corresponding to the sub-video data.

Specifically, the MIX unit 121 of the GPU 120 executes the blending process for blending a surface of 1920×1080 pixels (the color of pixels=black, the alpha value of pixels=0), a surface of sub-video data of 720×480 pixels, and a surface of sub-picture data of 720×480 pixels. Thereby, the MIX unit 121 calculates graphics data for forming a screen picture of 1920×1080 pixels, and alpha data of 1920×1080 pixels. The surface of 1920×1080 pixels is used as a lowest surface, the surface of the sub-video data is used as a second lowest surface, and the surface of the sub-picture data is used as an uppermost surface.

In the screen picture of 1920×1080 pixels, the color of each pixel in the area, where neither sub-picture data nor sub-video data is present, is black. The color of each pixel in the area, where only sub-picture data is present, is the same as the normal color of each associated pixel of the sub-picture data. Similarly, the color of each pixel in the area, where only sub-video data is present, is the same as the normal color of each associated pixel of the sub-video data.

In the screen picture of 1920×1080 pixels, the alpha value corresponding to each pixel in the area, where neither sub-picture data nor sub-video data is present, is zero. The alpha value of each pixel in the area, where only sub-picture data is present, is the same as the normal alpha value of each associated pixel of the sub-picture data. Similarly, the alpha value of each pixel in the area, where only sub-video data is present, is the same as the normal alpha value of each associated pixel of the sub-video data.

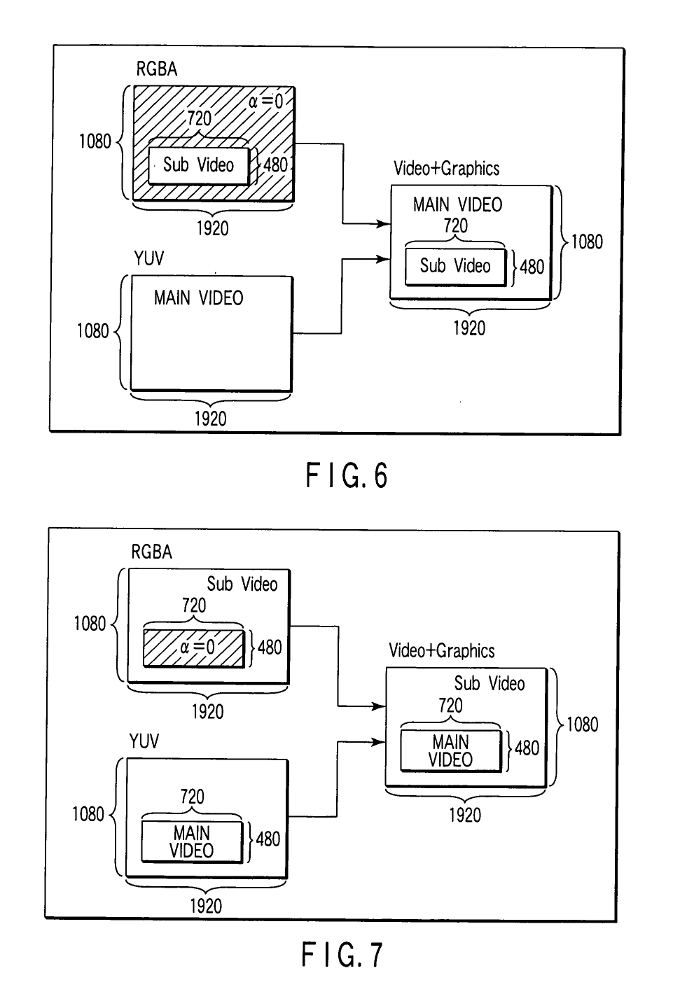

FIG. 6 shows a state in which sub-video data of 720×480 pixels is overlaid on main video data of 1920×1080 pixels.

In FIG. 6, graphics data is generated by a blending process that blends a surface of 1920×1080 pixels (the color of pixels=black, the alpha value of pixels=0) and a surface of sub-video data of 720×480 pixels on a pixel-by-pixel basis.

As has been described above, output picture data (Video+Graphics), which is output to the display device, is generated by blending the graphics data and main video data.

In the graphics data of 1920×1080 pixels, the alpha value of each pixel in the area, where the sub-video data of 720×480 pixels is absent, is zero. Accordingly, the area where the sub-video data of 720×480 pixels is absent is transparent. In this area, the main video data is displayed with the degree of non-transparency of 100%.

Each pixel of the sub-video data of 720×480 pixels is displayed on the main video data with a degree of transparency that is designated by the alpha data corresponding to the sub-video data. For example, a pixel of sub-video data with an alpha value=1 is displayed with 100% non-transparency, and a pixel of main video data corresponding to this pixel position is not displayed.

As is shown in FIG. 7, main video data, which is reduced to a resolution of 720×480 pixels, can be displayed on a partial area of sub-video data that is enlarged to a resolution of 1920×1080 pixels.

In one embodiment, the display mode illustrated in FIG. 7 is realized using a scaling function that is performed by the GPU 120 and a scaling function that is performed by the video decoder 25.

Specifically, in accordance with an instruction from the CPU 11, the GPU 120 executes such a scaling process as to gradually increase the resolution (picture size) of sub-video data up to 1920×1080 pixels. This scaling process is executed using pixel interpolation. As the resolution of the sub-video data becomes higher, the size of the area where the sub-video data of 720×480 pixels is not present (i.e. area with alpha value=0) gradually decreases within the graphics data of 1920×1080 pixels. Thereby, the size of the sub-video data, which is overlaid on the main video data and displayed, gradually increases, while the size of the area with the alpha value=0 gradually decreases. If the resolution (picture size) of the sub-video data reaches 1920×1080 pixels, the GPU 120 executes a blending process that overlays, on a pixel-by-pixel basis, a surface of, e.g., 720×480 pixels (the color of pixels=black, the alpha value of pixels=0) on the sub-video data of 1920×1080 pixels. Thus, the area of 720×480 pixels with the alpha value=0 is disposed on the sub-video data of 1920×1080 pixels.

On the other hand, in accordance with an instruction from the CPU 11, the video decoder 25 executes the scaling process that reduces the resolution of main video data to 720×480 pixels.

The main video data that is reduced to 720×480 pixels is displayed on an area of 720×480 pixels with the alpha value=0, which is disposed on the sub-video data of 1920×1080 pixels. Specifically, the alpha data that is output from the GPU 120 can also be used as a mask for limiting the area where the main video data is to be displayed.

As stated above, the alpha data that is output from the GPU 120 can freely be controlled by software. Thus, the graphics data can effectively be overlaid on the main video data and displayed. Thereby, video expression with high interactivity can easily be realized. Furthermore, since the alpha data is automatically transferred along with the graphics data to the blending process unit 30 from the GPU 120, the software does not need to recognize the transfer of alpha data to the blending process unit 30.

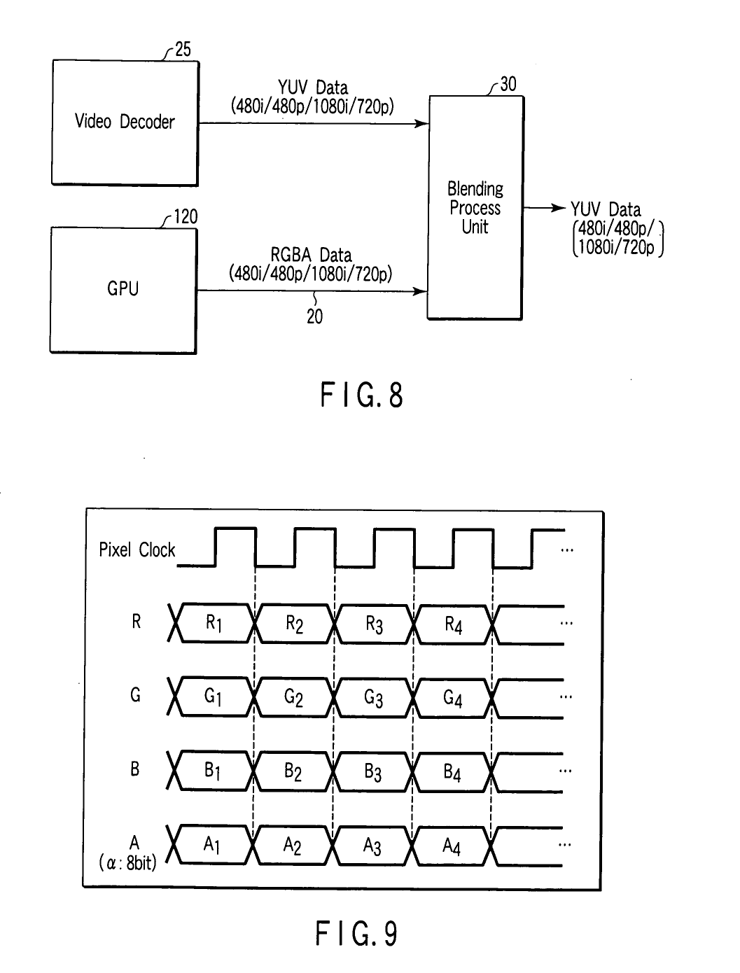

Next, referring to FIG. 8, a description is given of the operation for transferring the main video data and graphics data to the blending process unit 30.

The main video data is transferred as a digital YUV video signal from the video decoder 25 to the blending process unit 30. Depending on AV content that is included in an HD-DVD stream, there can be a case of using not HD (High Definition)-standard main video data but SD (Standard Definition)-standard main video data. Thus, the video decoder 25 is configured to support both SD and HD. The number of vertical lines of main video data, which is output from the video decoder 25, is any one of 480i, 480p, 1080i and 720p. In this case, 480i is the number of vertical lines of an SD-standard interlace picture, 480p is the number of vertical lines of an SD-standard progressive picture, 1080i is the number of vertical lines of an HD-standard interlace picture, and 720p is the number of vertical lines of an HD-standard progressive picture.

The GPU 120 outputs the alpha-data-added graphics data to the graphics bus 20 as an RGBA-format digital video signal. The resolution of a screen picture of the alpha-data-added graphics data is equal to that of a screen picture of main video data. That is, under the control of the CPU 11, the GPU 120 outputs the alpha-data-added graphics data, which corresponds to any one of 480i, 480p, 1080i and 720p.

FIG. 9 illustrates a state in which alpha-data-added graphics data is transferred via the graphics bus 20.

The graphics bus 20 has a 32-bit width. As is shown in FIG. 9, graphics data (RGB=24 bits) and alpha data (A=8 bits) are transferred via the graphics bus 20 in sync with a pixel clock signal. The pixel clock signal is output from a pixel clock generator (PLL: Phase-Locked Loop), which is provided, for example, within the GPU 120. Symbols R1, G1, B1 and A1 represent four components of red, green, blue and transparency (alpha) of a first pixel. Similarly, R2, G2, B2 and A2 represent four components of red, green, blue and transparency (alpha) of a second pixel.

In this way, the graphics data (RGB) and alpha data (A) are sent to the blending process unit 30 in the state in which these data are synchronized on a pixel-by-pixel basis. Thus, blending of graphics data (RGB) and main video data (YUV) can easily be executed without providing the blending process unit 30 with a circuit for synchronizing the graphics data (RGB) and alpha data (A).

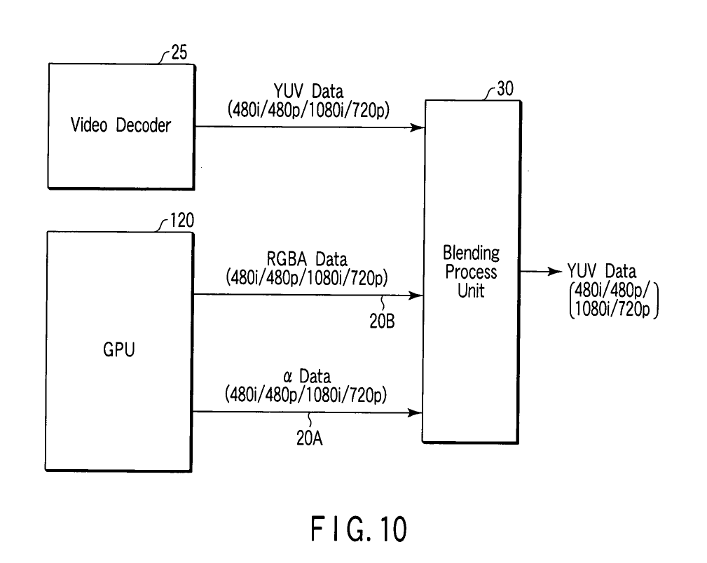

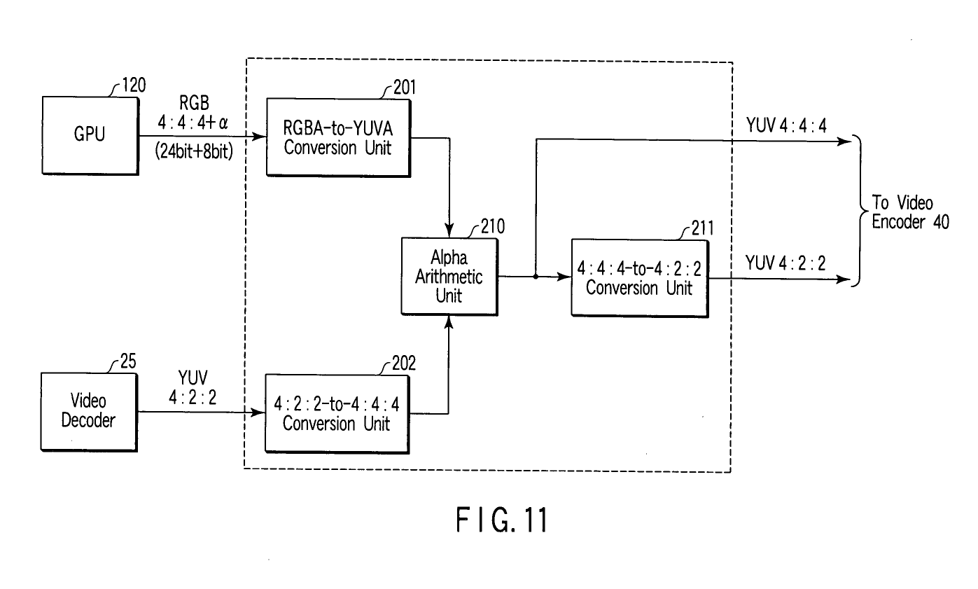

It is not necessary to transfer the alpha data (A) and graphics data (RGB) via the same bus. As is shown in FIG. 10, it is possible to transfer the alpha data (A) and graphics data (RGB) via different transmission lines. In FIG. 10, the alpha data (A) is transferred from the GPU 120 to the blending process unit 30 via a first graphics bus 20A, and the graphics data (RGB) is transferred from the GPU 120 to the blending process unit 30 via a second graphics bus 20B. The graphics buses 20A and 20B are provided between the GPU 120 and blending process unit 30.

Next, referring to FIG. 11, an example of the structure of the blending process unit 30 is described.

Video data, which is output from the video decoder 25, is 4:2:2 format YUV data in which the resolution of a chrominance signal is lower than that of a luminance signal. On the other hand, graphics data, which is output from the GPU 120, is RGB data. If the color space of the graphics data is converted from the RGB color space to a YUV color space, the graphics data becomes 4:4:4 format YUV data in which the resolution of a luminance signal is equal to that of a chrominance signal.

In order to blend the graphics data and video data on the YUV color space, the blending process unit 30 includes, as shown in FIG. 11, an RGBA-to-YUV conversion unit 201, a 4:2:2-to-4:4:4 conversion unit 202, an alpha arithmetic unit 210, and a 4:4:4-to-4:2:2 conversion unit 211.

Alpha-data-added graphics data (RGBA) from the GPU 120 is sent to the RGBA-to-YUV conversion unit 201. The RGBA-to-YUV conversion unit 201 converts the color space of the graphics data (RGB) from the RGB color space to the YUV color space, thereby generating YUV 4:4:4 format alpha-data-added graphics data (YUVA). The alpha value that is added to the RGB data is directly used for the alpha data that is added to the YUV 4:4:4 format graphics data. The generated graphics data (YUVA) is delivered to the alpha arithmetic unit 210.

The YUV 4:2:2: format video data from the video decoder 25 is sent to the 4:2:2-to-4:4:4 conversion unit 202. The 4:2:2-to-4:4:4 conversion unit 202 upsamples the YUV 4:2:2: format video data, and generates YUV 4:4:4 format video data. The YUV 4:4:4 format video data is sent to the alpha arithmetic unit 210.

Based on the alpha data (A) of the alpha-data-added graphics data (YUVA), the alpha arithmetic unit 210 executes an arithmetic operation (alpha blending arithmetic operation) for blending the graphics data (YUV 4:4:4) and video data (YUV 4:4:4) on a pixel-by-pixel basis, thereby generating YUV 4:4:4 format output picture data. The YUV 4:4:4 format output picture data is sent directly to the video encoder 40, or the YUV 4:4:4 format output picture data is once downsampled to a YUV 4:2:2: format via the 4:4:4-to-4:2:2 conversion unit 211 and then sent to the video encoder 40.

As has been described above, in the HD-DVD player according to the present embodiment, the decoding process for graphics and the decoding process for sub-audio, as well as the decryption process and separation process that correspond to preceding-stage processes for reproduction, are realized by software (program). Thus, even if a change in system specifications (e.g. a change in specifications relating to graphics processing) occurs in the future, this HD-DVD player can easily cope with such a change by updating the software. In addition, the decoding process, mixing process and blending process for main video and main audio, which require a great deal of processing, are realized by dedicated hardware. Therefore, high-quality video/audio reproduction can be maintained.

As has been described above in detail, the present invention makes it possible to flexibly cope with a change in specifications, etc.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A reproducing apparatus comprising:
an execution unit that executes a separation process by a program on a motion video stream including first video data, and graphics data that includes second video data, and executes a decoding process by a program on the second video data that is obtained through the separation process;
a decoder that decodes the first video data, which is obtained through the separation process; and
a blending process unit that blends the first video data, which is decoded by the decoder, and the graphics data including the second video data, which is decoded by the decoding process in the execution unit.

2. The reproducing apparatus according to claim 1, wherein:
the graphics data includes still picture data; and
the execution unit executes a decoding process by a program on the still picture data that is obtained through the separation process.

3. The reproducing apparatus according to claim 1, wherein:
the graphics data includes navigation data for displaying operation guidance; and
the execution unit executes a decoding process by a program on the navigation data that is obtained through the separation process.

4. The reproducing apparatus according to claim 1, wherein the execution unit executes, prior to executing the separation process, a decryption process by a program on the motion video stream.

5. The reproducing apparatus according to claim 1, further comprising a graphics process unit that outputs the graphics data including the second video data, along with alpha data that indicates a degree of transparency of each of pixels, to the blending process unit.

6. The reproducing apparatus according to claim 5, wherein the blending process unit executes a blending process between the first video data and the graphics data on the basis of the alpha data that is sent from the graphics process unit.

7. The reproducing apparatus according to claim 1, wherein an amount of processing of the first video data is greater than an amount of processing of the second video data.

8. A reproducing apparatus comprising:
an execution unit that executes a separation process by a program on a motion video stream including first video data, first audio data, graphics data that includes second video data, and second audio data, executes a decoding process by a program on the second video data that is obtained through the separation process, and executes a decoding process by a program on the second audio data that is obtained through the separation process;
a video decoder that decodes the first video data, which is obtained through the separation process;
an audio decoder that decodes the first audio data, which is obtained through the separation process;
a blending process unit that blends the first video data, which is decoded by the video decoder, and the graphics data including the second video data, which is decoded by the decoding process in the execution unit; and
a mixer circuit that mixes the first audio data, which is decoded by the audio decoder, and the second audio data, which is decoded by the decoding process in the execution unit.

9. The reproducing apparatus according to claim 8, wherein:
the graphics data includes still picture data; and
the execution unit executes a decoding process by a program on the still picture data that is obtained through the separation process.

10. The reproducing apparatus according to claim 8, wherein:
the graphics data includes navigation data for displaying operation guidance; and
the execution unit executes a decoding process by a program on the navigation data that is obtained through the separation process.

11. The reproducing apparatus according to claim 8, wherein an amount of processing of the first video data is greater than an amount of processing of the second video data, and an amount of processing of the first audio data is greater than an amount of processing of the second audio data.
